(19) United States
(12) Patent Application Publication
(10) Pub. No.: US 2010/0006646 A1
(43) Pub. Date: Jan. 14, 2010

(54) HOME GROCERY INVENTORY SYSTEM

(76) Inventor: Craig R. Stiller, Pawleys Island, SC (US)

Correspondence Address: PASSE' INTELLECTUAL PROPERTY, LLC, 1717 BRASSFIELD RD., RALEIGH, NC, 27614, US

(21) Appl. No.: 12/169,250

(22) Filed: Jul. 8, 2008

(51) Int. Cl. G06K 7/10; G06F 19/00

(52) U.S. Cl. 235/383; 235/385; 235/439

(57) ABSTRACT

The present invention relates to a system and method for maintaining household inventories of items. The invention relates to placing RFID tags to items with a shopper possessing a personal RFID reader. The reader can synchronize with a computer such as a store computer, a personal computer or the computer can be part of the reader. An internet site capable of analyzing information on the computer then can provide a wide range of products and services based on the item inventory analysis back to the computer.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present system relates to a system and method for managing the purchase of retail home items such as groceries. In particular, the invention relates to a system and method using RFID to manage the purchase and stocking of items purchased at a grocery store.

2. Description of Related Art

The use of radio frequency identification (RFID) tags on items to identify them as they move through the commercial setting is well known. Stores will tag an individual item in order to keep track of store inventory, handle reordering, re-pricing, and prevention of theft and the like. They can also be used to track purchasing data such as time of purchase, store location of an item and the like. An RFID device is a passive device that is capable of emitting a response when it is in the presence of an electromagnetic field. The devices are now made relatively small and are configured so that each RFID device emits a unique response when it receives a particular radio signal. RFID's have been used recently on retail items such as clothing, recordings, and are becoming cheaper and more widely available.

A number of different advances in use of RFIDs have been described in the art. In U.S. Pat. No. 7,156,303 issued Jan. 2, 2007 to Holzman at NCR Corporation there is disclosed a shopping system and method which is said to reduce resources including an item recording computer for recording item identification and recording shopper identification about the shopper. The system then prints a receipt for the shopper at the end of the shopping event.

In U.S. Pat. No. 7,311,251 issued Dec. 25, 2007 to White of NCR Corporation there is a system and method of completing a transaction with RFID labels using a portal to read the labels. The system includes a computer for obtaining information and storing information and process a receipt for printing. In published US application 2002/0065680 published May 30, 2002 to Kojima et al, there is a method and system for retail merchandise management wherein a customer borrows a portable RFID terminal, purchases items, then returns to the RFID terminal to get a receipt after settling payment.

In US published patent application 2003/0214387 published Nov. 20, 2003 to Giaccherini there is disclosed an inventory location system wherein RFIDs to keep track of files or wireless checkout or analyzes the inventory of goods within a customer's home to enhance sales and marketing strategies. In addition other means are used to retrieve information about the product stored in an RFID. In US patent application 2007/0069011 published Mar. 29, 2007 to Barton et al., there is disclosed a point of purchase apparatus using an RFID tag. The device allows the use of the RFID tag to have a point of purchase means of producing a total for purchasing the goods and checkout the purchased items.

### BRIEF SUMMARY OF THE INVENTION

The present invention relates to an interactive system of personal RFID readers stores with RFID tagged merchandise and an internet site which helps coordinate the inventory and purchasing for an individual using the system.

Accordingly, in one embodiment of the present invention there is a shopping system comprising:
a) a plurality of retail stores, each store having items for purchase with an RFID identification tag that remains with the item after purchase;
b) a plurality of portable RFID readers, each reader assigned to a selected individual and capable of reading the RFID tags of the items selected by the individual for purchase, preparing a list of the items selected for purchase and synchronizing the list to a selected computer;
c) a computer assigned to each of the plurality of retail stores capable of receiving the list from the reader and preparing a transaction record of the list; and
d) a computer assigned to each of the selected individuals capable of receiving the list from the assigned reader and maintaining a personal list of inventory at a given location for the selected individual.

In yet another embodiment there is a shopping method comprising:
a) identifying a plurality of items for sale in a store by placing an RFID tag on the items;
b) a shopper with a personal RFID reader selecting tagged items for purchase, identifying the items with the reader and creating a list and purchasing the items on the list;
c) synchronizing the list from the reader to a computer assigned to the shopper to create an inventory;
d) interacting with an internet site that analyzes the shopper's inventory.

In yet another embodiment of the invention there a system for personal shopping comprising:
a) a shopper with a RFID reader operationally linked to one or more stores having RFID tagged items for sale and to a RFID related internet site;
b) the RFID related internet site operationally linked to the shopper and to one or more stores; and
c) one or more stores operationally linked to the shopper's RFID reader and the RFID related internet site.

Another embodiment of the invention is a system for personal shopping comprising:
a) a personal RFID reader equipped with a means for collecting information about obtained items with an RFID tag and synchronizing the item information to a computer; and
b) an internet site capable of analyzing the item information on the computer and providing analysis information to the computer.

### BRIEF DESCRIPTION OF THE DRAWINGS

FIG. 1 is a diagram of a shopping system

FIG. 2 is a flow diagram illustrating the method of the shopping system

FIG. 3 is a relationship diagram of a web site in the shopping system

### DETAILED DESCRIPTION OF THE INVENTION

In the present invention it has been discovered that establishing a relationship with a shopper having a private RFID reader and a store can produce paperless receipts at a retail store, provide home inventory and shopping without need for a global home reader. The use of a web site provides shopping, software and interaction between the shopper and retail store not possible without the RFID reader. In addition, use of a web (internet) site allows for creating home inventory, product analysis, customer delivered product information and improving the shopping overall quality.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described.

In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein the term “stores” refers to stores where an individual would go to purchase items for day to day use. This could be a retail store, a wholesale store, one of the typical warehouse type stores or the like where the shelves or the like are stacked with merchandise. In one embodiment, the store would be a grocery store with each of items available in the store available for purchase having a RFID identification tag on it. It would be a requirement of the present invention that items so tagged would be tagged with the intention that the RFID tags remain with the product as opposed to removed at the point of purchase or otherwise disposed of until the item is consumed or otherwise disposed of. Consumers and stores benefit greatly from the present invention since perishable items such as groceries are consumed fairly rapidly and are often replaced with similar or like items. In addition, the number of items in the typical household is relatively large, making the keeping of a reasonable household inventory list difficult if not impossible. For instance, if there needed to be any hand entry of the addition or removal of items into a database or even worse, a list kept by hand written methods, the effort required to keep such inventory is usually too great a burden to consistently perform the task for any great length of time.

RFID tags are well known within the industry and one skilled in the art would be capable of matching the tag to the item for this system. Typical information on an RFID tag attached to an item in the present invention might be the product ID, date of manufacture, expiration date, selling price, cost, tracking number and any other relevant information about the product that a store or for that matter the shopper might need. Obviously, cost of an RFID tag may be an issue in deciding which RFID tag to use but in general cost aside the system works with any RFID tag. A truly disposable tag would be used in one embodiment. A disposable tag would be one that is of a cost and ease of use such that the tag could go with the item upon purchase. The tag could then possibly be recycled to make it cost effective, being reprogrammed for future use, or be so cheap to manufacture, if possible, that it could be disposed of after each use with the item tagged. In some embodiments the RFID tags are placed on items by the store where a shopper purchases the item. In other embodiments where a shopper purchases or obtains an item that does not have an RFID tag the shopper can add a tag to the item in order to be able to add the item to the household inventory after being read by the RFID reader. In yet another embodiment of the present invention the RFID tag can be supplied by the manufacturer or by a third party vendor like a wholesaler or the like.

In this particular invention there is usually a plurality of RFID readers for a large system, however usually only one per shopper. Each RFID reader is a portable handheld version. Each reader will be owned, leased or otherwise assigned to the user or selected individual such that not only is it used individually in a store of the present invention, it can be taken home to use to maintain household inventories, synchronize (either upload or download information) to a personal computer, interact or synchronize with the web site and the like. In one embodiment, the RFID reader can be incorporated into a PDA, such as a small handheld computer or a cell phone type PDA. With the reader incorporated into a cell phone or PDA there would be no reason to carry two devices, and it would be more likely that a user would actually have the RFID reader with them each time a purchase from a store that has the tagged items is made. In this embodiment, the RFID reader and the computer could be the same device and by synchronizing to the computer would also mean the PDA computer could access the information that is generated by the RFID reader on the PDA and vice versa.

The RFID reader would have additional capability under some embodiments of the present invention. In one embodiment, the RFID reader would be able to prepare a list of items for purchase. It could accomplish that in one embodiment by making a first reading of items in a selected location such as at a household at a selected time and then at a second selected time making a second reading of items in the selected location and comparing the two inventories. Items missing in the second inventory could be considered items for purchase. Further, the reader could take a reading of the RFID tagged items around the store while the purchaser is in the store. Once the reading is complete, a list of those items could be compiled. The list could be generated by the computer or by the internet site. The reader could then synchronize the list to a selected computer, print it out to use as a shopping list or to a PDA for taking to the store for shopping purposes. The computer could also be a computer at the checkout register for preparing a transaction list such as a bill or invoice of the items or could be the personal computer at the individual's home for synchronizing the information to the web site or a personal list such as an inventory list, database or the like.

In one embodiment, the retail store has a computer assigned to it that is capable of receiving the list from the RFID reader and preparing the transaction list for example an invoice or a bill and can charge the customer either by producing a conventional receipt or in one embodiment communicates with the RFID reader or other device that the purchaser has in order to accomplish a paperless transaction. Such wireless communication such as synchronization can be by RF means or Bluetooth or the like and such means are known in the art. The communication could be by hard wire means such as the purchaser plugging the RFID reader directly into the computer (register) of the retail store.

When the shopper, i.e. the selected individual, returns home, the list of items purchased can be synchronized from the RFID reader assigned to the selected individual to a computer at that location or as desired another location, if it is not already accomplished, say for example, when the RFID reader and computer are one device. In other embodiments, items purchased from stores without RFID tags could have tags added by the shopper for addition to the household inventory purposes. Once the list is synchronized with the computer, the list can be maintained on the computer or on the internet site as a database or household inventory. The database can be updated by taking global readings of all of the items at the household location and comparing the list to a previously prepared list as described above. Any items not on the new list that were on the previous list can be considered gone and a new inventory list prepared. The missing items can be put together in a list for shopping to replace the missing items. In one embodiment, only selected items would be noted for replacement so that items that are a single purchase will not constantly be put on the shopping list. Basic items like milk and eggs and the like can be done such that, where appropriate and possible, when the inventory reaches a level less than completely gone, the item is placed on the shopping list. Likewise, after a period of time such as a fixed period or based on the expiration of the item that is on the database or in the RFID tag information, an item could be considered expired or gone. A list of those items could be generated for replacement and for being thrown away.

In another embodiment, the list is synchronized to the computer and then to a managing web site (internet site). The internet site then maintains and updates software or processes necessary to analyze and maintain the database of inventory items. The web site can for example, analyze by interacting with the stores where items are purchased and notify the purchaser of specials, coupons, create a shopping list and the like for downloading to the RFID reader, PDA computer or the like. The shopping list can then automatically erase items from the shopping list as they are scanned for purchase or actually purchased at the corresponding store. The download can then also make note of shopping patterns and suggest related items for purchase and other sale items as desired to make the system more interactive and sales oriented. Once the new items are purchased and the purchaser again makes a synchronization of items, the inventory is changed accordingly.

The present invention further, in one embodiment, relates to a system of interactive parts. A shopper also called a selected individual is operationally linked by an RFID reader to stores having RFID tagged items for sale and to a RFID related web site for managing the list of items. The RFID web site is in turn operationally linked to the shopper and also to one or more stores having RFID tagged items for sale at the stores by the shopper. Lastly, the system incorporates one or more stores having RFID tagged items for sale that is operationally linked to the shopper's RFID reader and the RFID related web site. The interrelational operational link between the parties allows for the active and interactive maintaining of inventories, shopping lists and the like as described and more. One skilled in the art would be able to take the interactive operational link and add other facets of operation to build on the operational link between the elements of the invention.

In yet another embodiment of the present invention, there is a system for personal shopping comprising a personal RFID reader that is capable of collecting information about obtained items that have an RFID tag and then synchronizing the item information to a computer. The computer can be a personal computer or a store computer as described above. The system also further comprises an internet site capable of analyzing the items on the computer and providing the analysis information to the computer. The system then can provide a number of activities. Either the computer or the internet site can prepare an inventory or a shopping list. The internet site can provide shopping suggestions based on buying patterns and types of products that appear in the inventory. The internet can provide product information about the items in inventory such as nutritional information, composition of the product, product recalls, expiration dates and the like. In one embodiment, the computer or the internet site keeps track of expiration dates of items with expiration dates and in addition in one embodiment sends reminders to the shopper in the event a particular item is past the expiration date. It could also send reminders that an expiration date is approaching. Even further, where no expiration date is associated with the product, the shopper could assign or change an expiration date, for example, when freezing an item, a 4 or 5 day expiration might be changed to 6 months.

The present invention also includes another embodiment of a method. The shopping method involves the process of tagging items for retail sale with RFID tags. A shopper enters the store with a personal RFID reader and selects items for purchase and uses the RFID reader to create a list of items being purchased or obtained. The list is then synchronized to a shopper's computer to create an inventory and then interacting with an internet site that provides analysis of the inventory. By analysis is meant, but not limited to, preparing shopping lists, expiration lists, suggested purchases, coupons or any of the items described above. The analysis could also provide sale items and the like as described above or as desired by the parties to the method. The method can even provide a receipt of purchased items from a store by means of the web site interacting with the store itself. The internet site can provide information as described above as well as track purchases, analyze purchasing habits, and suggest purchases and the like as desired by the users of the system.

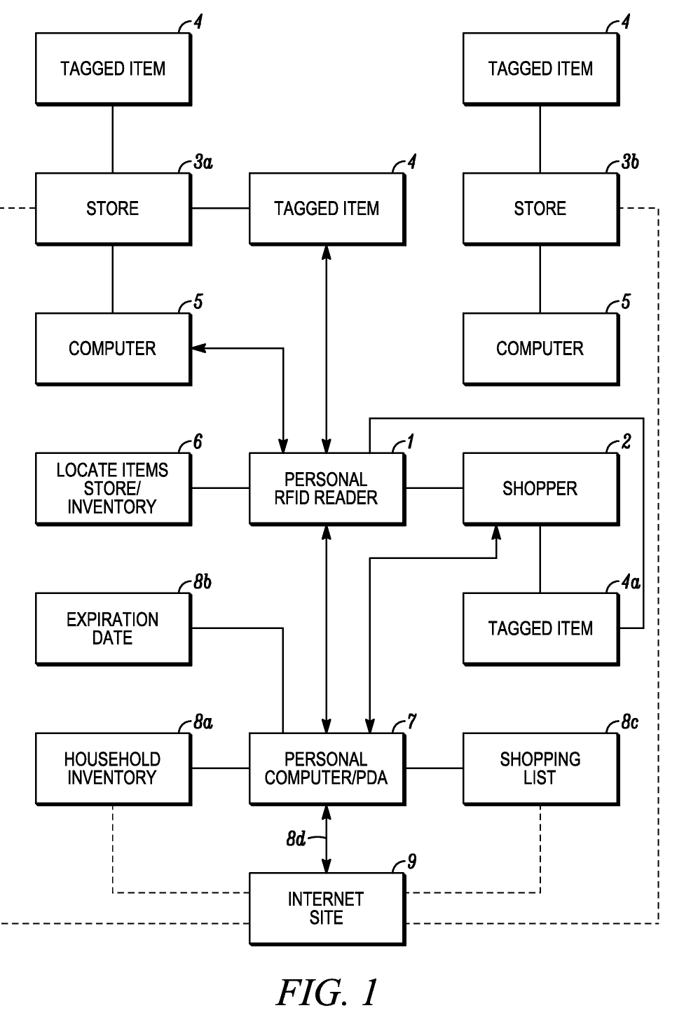

Now referring to the drawings, FIG. 1 is a diagram of an embodiment of the invention. The invention in this FIG. 1 is centered on a personal RFID reader 1. As noted above, the personal reader is assigned to a shopper by purchase or lease and remains with the individual shopper 2 as opposed to something being picked up and used just in the individual store. In this view there are two stores 3a and 3b. This view would indicate that shopper 2 had used the reader 1 to shop at store 3a and not store 3b. Each store 3a and 3b is equipped with RFID tagged items 4. The tagged items 4 desired for purchase or other obtained items 4a that are tagged or tagged by shopper 2 are read by the reader 1 and information is relayed to the reader that is on the RFID tag. The store then can synchronize the RFID list of purchased items to computer 5 and an invoice and receipt created in any number of ways as described above. In addition, the RFID reader 1 can be used to locate items by searching for them at the store or at home where the items are stored to create a household inventory 8a. Once the shopper is at home or other location where the personal computer 7 is positioned the shopper 2 can use the RFID reader 1 to synchronize an inventory or list of items. The computer can synchronize as well giving the RFID reader or shopper shopping lists coupons or anything else on the personal computer that relates to the shopping that are received from the web site via connection 8d. The personal computer can keep an inventory 8a, shopping list 8c, expiration dates 8b or other data desired in order to work with the inventory list as described above. In addition, the personal computer 7 can have a line with a web site dedicated to the RFID inventory and stores and the like indicated by the dashed lines. The web site 9 can keep the inventory, lists and the like or just create them for synchronizing. The web site as described above can also provide an operational link between the shopper 2 and the stores having the RFID tagged items 4.

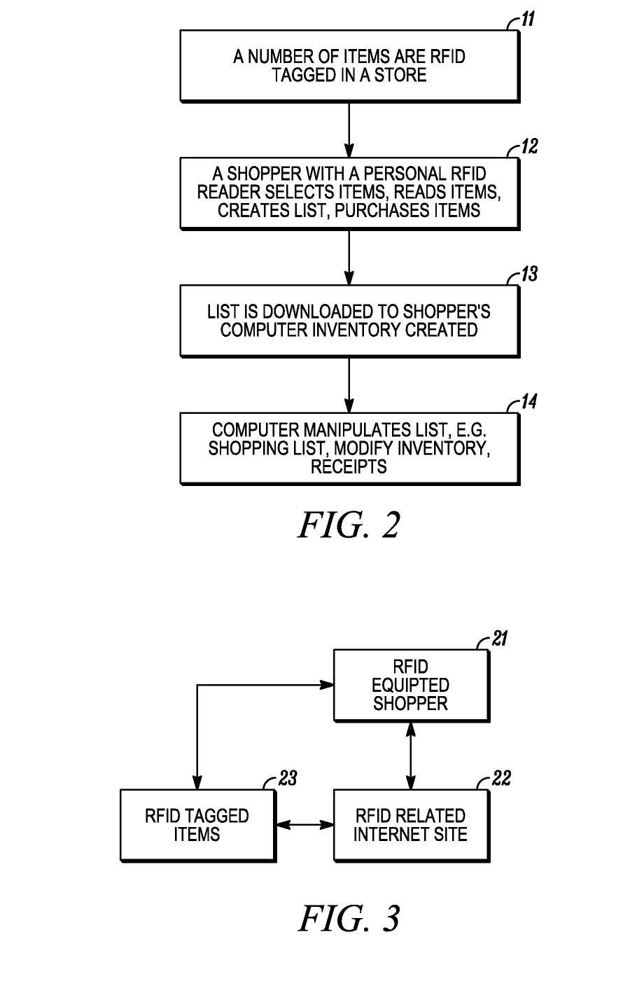

FIG. 2 shows a flow chart of an embodiment of the method of the present invention. The steps here and in the claims are shown in a particular order but one skilled in the art could perform these steps in any reasonable order without departing from the invention and the information should be so interpreted. First, a store will take items for sale in the store and a number of items will be tagged with an RFID tag 11. The RFID tag could have any type of information desired and within the skill of the art as described above. The next step is a shopper with a personal RFID reader selects one or more items from the store and uses the reader to read the items, create a list of the items and then purchase the items 12. Next the list is synchronized to the shoppers computer and an inventory created 13 and finally the computer either with software or a web site manipulates the list to produce shopping list inventories, modified inventories and receipts, and the like 14.

FIG. 3 shows an embodiment of the interrelationship of the system of the present invention with a block diagram. A RFID equipped shopper 21 is operationally linked to one or more stores or just individual items having RFID tagged items and to a RFID related internet site 22. The RFID related internet site is operationally linked to the shopper 21 and to one or more stores having RFID tagged items for sale 23 or to just one or more RFID tagged items obtained by the shopper in any manner. The RFID tagged items 23 are also operationally linked to the shopper 21 and the internet site 22. This tri-interrelationship allows for the inter-reaction of the storage of the RFID information along with the marketing and sales activities of the store having items for sale. The internet site acts as the intermediate between the two and the reader a conduit for collection of information and for assisting in the decision making process.

The above description of individual embodiments is not intended to be limiting. Selection of different RFID tags, equivalents of the internet such as internet replacements, differing types of products and stores and the like are all within the contemplation of the invention and the claims which follow are to be so interpreted.

1-31. (canceled)

32. A system for maintaining a home inventory for a selected individual comprising:
a) a plurality of stores, each store having items for purchase with an RFID identification tag that remains with the item after purchase;
b) a portable RFID reader assigned to the selected individual capable of making successive inventories of the items in the individual's home by periodically reading the RFID tags of the items in inventory at the home of the individual and storing the RFID information about which items are in inventory for each reading;
c) a personal computer connected to a communication network assigned to the select individual for downloading the RFID information of each home inventory reading from the RFID reader;
d) a server computer connected to the communication network separate from the stores or the selected individual and designed to communicate information about the individual's home inventory with the personal computer; and
e) software on at least one of the personal computer or server computer to create a current list of items in inventory and separately a list of items which have been removed from inventory by comparing successive RFID readings of the items in inventory at the individual's home.

33. A system according to claim 32 wherein the personal computer creates the current list of inventory and the list of items removed from inventory.

34. A system according to claim 32 wherein the server computer creates the current list of inventory and the list of items removed from inventory.

35. A system according to claim 32 wherein a shopping list is created based on the items removed from inventory.

36. A system according to claim 35 wherein at least one of the plurality of stores is able to receive the shopping list from the RFID reader, the personal computer or the server computer.

37. A system according to claim 32 wherein at least one of the stores is able to send a list of items purchased by the individual to the personal computer or the server computer to add the purchased items to the inventory list by the software separate from the home inventory performed by the RFID reader.

38. A system according to claim 35 wherein the server computer is able to communicate information about items on the shopping list that are available at one or more of the plurality of stores.

39. A system according to claim 38 wherein the server computer can access data about items for sale at one or more of the plurality of stores over the communication network.

40. A method for taking inventory in an individual's home setting of items with an RFID tag which items have been purchased by the individual from a plurality of stores and brought to the home setting comprising:
a) taking periodic scans of the items with an RFID tag in inventory with an RFID reader to create an inventory list;
b) downloading each of the periodic scans in the RFID reader to a personal computer of the individual that is connected to a communication network;
c) comparing successive periodic scans and creating a list of items that have been removed from inventory;
d) create a shopping list from the list of items removed from inventory; and
e) providing a server computer separate from the individual or plurality of stores which has a connection to a communication network and communicates information about the individual's home inventory with the personal computer.

41. A method according to claim 40 wherein the personal computer creates the current list of inventory and the list of items removed from inventory.

42. A method according to claim 40 wherein the server computer creates the current list of inventory and the list of items removed from inventory.

43. A method according to claim 40 wherein at least one of the plurality of stores receives the shopping list from the RFID reader, the personal computer or the server computer.

44. A method according to claim 40 wherein at least one of the stores sends a list of items purchased by the individual at the store to the personal computer or the server computer to add the purchased items to the inventory list.

45. A method according to claim 40 wherein the server computer communicates information about items on the shopping list that are available at one or more of the plurality of stores.

46. A method according to claim 40 wherein the server computer can access data about items for sale at one or more of the plurality of stores over the communication network.
